(19) United States
(12) Patent Application Publication
(10) Pub. No.: US 2026/0326882 A1
(43) Pub. Date: Oct. 22, 2026

(54) GLAZED SYSTEM CONFIGURED TO PREVENT GLAZING FROM SLIPPING

(71) Applicant: SAINT-GOBAIN SULLY, SULLY-SUR-LOIRE (FR)

(72) Inventors: Jean-Benoît MAYEUX, SULLY-SUR-LOIRE (FR); Thomas TONDU, COURBEVOIE (FR)

(21) Appl. No.: 19/112,137

(22) PCT Filed: Sep. 15, 2023
(86) PCT No.: PCT/EP2023/075478

§ 371 Date: Mar. 14, 2025

(30) Foreign Application Priority Data
Sep. 16, 2022 (FR) 2209329

(51) Int. Cl. B64C 1/14; E06B 3/58

(52) U.S. Cl. CPC B64C 1/1492; E06B 3/5864

(57) ABSTRACT

A glazed system includes a glazing including structural plies, the glass panel being clamped in place by a structure. The glazed system further includes at least one blocking element, referred to as a primary blocking element, rigidly connected to the glazing in the clamping zone, at least one blocking element, referred to as a secondary blocking element, rigidly connected to the structure, the at least one primary and secondary blocking elements being configured to cooperate with one another when the glazing slips in the plane in which it extends, which slip is oriented towards the center of the glazing, so as to block the slippage.

### PRIOR ART

The present application belongs to the general field of glazing manufacture, particularly glazing for vehicles. It relates more particularly to a glazed system, to the use of this glazed system and to a vehicle equipped with said glazed system.

The invention finds a particularly advantageous application, although by no means limitative, in the case of a vehicle subjected to pressure differentials between an external environment (atmosphere) and the interior of said vehicle, such as an aircraft (e.g., commercial aircraft), a rail vehicle (e.g., train) or a maritime vehicle (e.g., ship, submarine).

Various ways of integrating a glazing with a plurality of structural plies into a vehicle structure are currently known. It is known, for example, that such glazing can be mounted in a “clamped” configuration, particularly (but not exclusively) when the vehicle is to be subjected to pressure differentials.

“Structural ply” conventionally refers to a rigid glass sheet constituting the glazing capable of forming a monolithic glazing itself, to ensure the mechanical strength thereof, in particular, and having an elastic modulus at least equal to 1500 MPa for example.

The term “clamped glazing” refers to the fact that, in the direction normal to the plane of the glazing, the glazing is held in place by the clamping of the structural plies by the vehicle structure, typically by two elements positioned on either side of the structural plies. By way of example, in the case of a glazing intended for an aeronautical application, this clamping can be achieved between an element called a “retainer” and another structural element positioned opposite the internal structural ply (that is, the structural ply arranged closest to the vehicle interior).

It should be noted that clamping can also apply to one or more sealing elements, such as one or more gaskets, inserted between the structural plies and the vehicle structure. A known configuration of this type is, for example, where the periphery of a clamped glazing is produced by overmolding a sealing gasket encapsulating all the components of the glazing, that is, in particular the said structural plies, but also possibly other elements, such as a stiffening shim (also known as a “compensating shim”) positioned in a housing of the gasket and fixedly attached to the internal structural ply.

In the glazing plane, the glazing is held in place in two ways. On the one hand, in a first direction of movement tending to increase the overlap of the structural plies with the vehicle structure at the clamping zone, the glazing is held in place by abutment with the vehicle structure at its edge. On the other hand, in a direction opposite to said first direction, support is ensured by the rigidity of the glazing, allowing minimal overlap between the glazing and the vehicle structure.

The functional requirements a clamped glazing subject to pressure differentials must meet include pressure resistance (that is, the glazing must remain in its housing), which must be guaranteed not only when the glazing is intact (standard case) but also in the event of breakage of a structural ply of the glazing (“fail safe”).

An additional requirement is sometimes added to this, referred to as the “double fail safe/full fail safe,” corresponding to the pressure resistance in the event of all structural plies of the glazing being broken. By way of example, in the context of an aeronautical application, this additional requirement aims to enable an aircraft to complete its flight without endangering the aircraft.

The clamp mounts that are currently available do not optimally meet this additional safety requirement, particularly for large glazing. Indeed, breakage of all the structural glass plies can lead to a loss of glazing rigidity. This loss of rigidity is itself likely to lead to a reduction in the overlap between the structural plies and the vehicle structure, through slippage in the glazing plane. This can result in airtightness defects, or even, in certain circumstances, sufficiently significant deflection of the glazing to cause it to fall out (and thus be lost).

It should be noted that the issues raised here are not limited to the case of a clamped glazing integrated into a vehicle, but ultimately concern any configuration wherein a glazing is used in a clamped assembly, such as a burglar-proof glazing.

### OVERVIEW OF THE INVENTION

The aim of the present invention is to remedy some or all of the disadvantages of the prior art, in particular those set out above, by proposing a solution which makes it possible to obtain a clamped glazing that meets the “full fail safe” requirement in the event of breakage of all its structural plies more effectively than the solutions of the state of the art. This solution is easy to install, and can be adapted to existing structures without altering their footprint.

To this end, and according to a first aspect, the invention relates to a glazed system comprising a glazing, for example a laminated glazing, comprising structural plies, the glazing being clamped in place by a structure. Said glazed system further comprises:
at least one blocking element referred to as a “primary blocking element”, rigidly connected to the glazing in the zone where the clamping is exerted by the structure,
at least one blocking element referred to as a “secondary blocking element”, rigidly connected to the structure,
said at least one primary and secondary blocking elements being configured to cooperate with one another when the glazing slips in the plane in which it extends, which slip is oriented towards the center of said glazing, so as to block said slippage.

Thus, the blocking elements of the glazed system according to the invention block the glazing from slippage and thus hold the edge of the glazing in its housing. In this way, pressure-tightness functions are guaranteed, even in the event of breakage of all or part of the structural plies.

When the glazing is subjected to forces likely to cause it to slip in its plane, these forces reinforce the link between each blocking element and the support to which it is attached.

These blocking elements are particularly easy to use, which makes the clamped glazing particularly simple to produce and install.

Moreover, the reduced size of the blocking elements, compared with the other elements of the glazed system, means that the overall dimensions of a glazed system as known in the state of the art advantageously remain unchanged. The invention can therefore be implemented very easily on a pre-existing vehicle structure.

By “said glazing being clamped by a structure” it is understood that in the assembled state of the glazed system, the glazing of the glazed system is clamped by said structure.

In particular embodiments, the glazed system may further comprise one or more of the following features, taken alone or in any technically feasible combinations.

In particular embodiments, said at least one primary and secondary blocking element are configured to have a blocking configuration wherein they cooperate with one another upon slippage of the glazing in the plane wherein it extends and oriented towards the center of said glazing, so as to block said slippage, said at least one primary and secondary blocking element being further configured to have a nominal configuration wherein they do not cooperate with one another when the glazing undergoes no slippage in said plane.

In particular embodiments, said at least one primary and secondary blocking element are configured to change from the nominal configuration to the blocking configuration upon slippage of the glazing in the plane wherein it extends and oriented towards the center of said glazing, so as to block said slippage.

In particular embodiments, said system comprises a plurality of primary blocking elements, as well as a plurality of secondary blocking elements, each primary blocking element being configured to cooperate with a single secondary blocking element.

In particular embodiments, said system comprises a single primary blocking element and/or a single secondary blocking element, each single blocking element extending continuously so as to form a closed loop within which the structural plies are arranged.

In particular embodiments:
at least two primary and secondary blocking elements configured to cooperate with one another are respectively rigidly connected to an external structural ply of the glazing and with a mounting element of the structure arranged opposite said external structural ply, for example a retainer, and/or
at least two primary and secondary blocking elements configured to cooperate with one another are respectively rigidly connected to a stiffening wedge (160) and a structural mounting element arranged opposite said internal structural ply, said wedge being housed in a seal (120), for example an overmolded seal wherein the structural plies are encapsulated at their periphery, and fixed to an internal structural ply of the glazing.

In particular embodiments:
said at least one primary blocking element is integral with the external structural ply or with the stiffening wedge, or
said at least one primary blocking element is attached and fixed to the external structural ply or to the stiffening wedge, for example by gluing, sintering, brazing or bolting.

In particular embodiments:
said at least one secondary blocking element is integral with said structural mounting element arranged opposite the external structural ply or the internal structural ply, or
said at least one secondary blocking element is attached and fixed to said structural mounting element arranged opposite the external structural ply or the internal structural ply, for example by gluing, sintering, brazing or bolting.

In particular embodiments, the cooperation between at least two of the primary and secondary blocking elements is effected directly or indirectly by means of respective contact surfaces of said primary and secondary blocking elements, said contact surfaces being inclined with respect to the plane of the glazing.

In particular embodiments, the angle of inclination of the contact surfaces to the plane of the glazing is between 5° and 60°, more particularly between 20° and 40°, preferentially equal to 25°.

According to a second aspect, the invention relates to the use of a glazed system according to the invention for a vehicle, for example of the aircraft, rail or maritime type, or for a building.

According to a third aspect, the invention concerns a vehicle comprising a glazed system according to the invention, for example of the aircraft, rail or maritime type.

According to a fourth aspect, the invention concerns an assembly comprising a structure and a glazed system as previously defined.

According to a fifth aspect, the invention relates to the use of a glazed system as defined above for a vehicle, for example of the aircraft, rail or maritime type, or for a building.

According to a sixth aspect, the invention concerns a vehicle comprising a glazed system as defined above, for example of the aircraft, railway or maritime type.

### BRIEF DESCRIPTION OF THE DRAWINGS

Other features and advantages of the present invention will emerge from the non-limiting description given below, with reference to the appended drawings that illustrate an exemplary embodiment thereof. In the figures:

FIG. 1 schematically shows a particular embodiment of a glazed system according to the invention;

FIG. 2 schematically shows another embodiment of a glazed system according to the invention;

FIG. 3 schematically shows another embodiment of a glazed system according to the invention.

### DESCRIPTION OF EMBODIMENTS

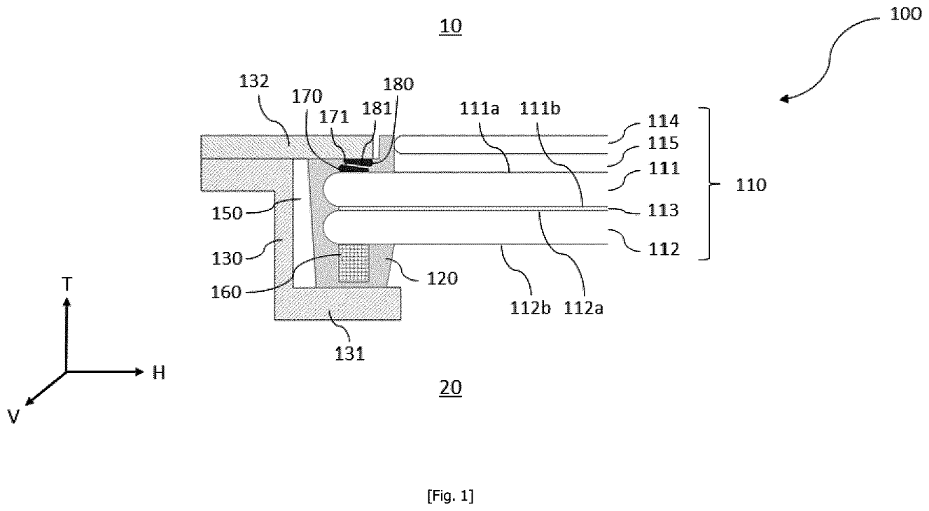

FIG. 1 schematically shows a particular embodiment of a glazed system 100 according to the invention.

In the remainder of the description, the horizontal, vertical, and transverse directions will be used without limitation in reference to the axis system (H, V, T) shown in FIG. 1. Also, the glazed system 100 of FIG. 1 is shown in cross-section (that is, within the thickness of a glazing of said glazed system 100 and described below).

By convention, the terms “upper” and “lower” or “top” and “bottom” or “above” and “below” are used in reference to the transverse orientation. The terms “left” and “right” are used to refer to horizontal orientation.

In FIG. 1, the glazed system 100 is shown as already integrated (attached) into an aircraft. The remainder of the description is aimed more specifically at a commercial aircraft, also known simply as an “airplane”. However, the invention can be applied, without limitation, to any type of aircraft designed to be subjected to pressure differentials between an external environment 10 and the interior 20 of said aircraft, such as a cargo aircraft, a fighter aircraft, a helicopter, and so on.

For the rest of the description, it is assumed that the glazed system 100 is part of the cockpit glazing of said commercial aircraft, more specifically the windshield of this cockpit glazing. However, such arrangements are not a limitation of the invention, and there is nothing to preclude the possibility of the glazed system 100 forming part of another cockpit window, such as a side window of the cockpit, or forming part of a cabin window such as a porthole.

Furthermore, it is important to note that considering an integration of the glazed system 100 in an aircraft type vehicle is only one alternative implementation of the invention. Thus, in more general terms, any type of vehicle for which a clamped glazing can be integrated into the structure can be envisaged. This applies in particular to any type of vehicle designed to be subjected to pressure differentials between exterior and interior, such as a rail vehicle, a maritime vehicle (e.g., a ship or submarine for wheelhouse or porthole glazing, etc.), an armored vehicle, etc.

In the present embodiment, the glazed system 100 comprises a laminated glazing 110. Said laminated glazing 110 comprises a set of structural plies including a first structural ply 111 as well as a second structural ply 112 bonded to the first structural ply 111 via an adhesive interlayer 113.

In particular, and as illustrated in FIG. 1:
the first structural ply 111, known as the “external structural ply,” is a sheet of glass arranged as close as possible (among the structural plies of laminated glazing 110) to the aircraft's external environment 10. Said external ply 111 comprises an upper face 111a and a lower face 111b;
the second structural ply 112, known as the “internal structural ply,” is a sheet of glass arranged as close as possible (among the structural plies of laminated glazing 110) to the interior environment 20 of the aircraft. This is a glass sheet bonded to the first structural ply 111 by means of said adhesive interlayer 113. Said internal ply 112 comprises an upper face 112a and a lower face 112b.

In the embodiment described here, the outer and inner plies 111, 112 are made of organic glass, for example stretched polymethyl methacrylate (stretched PMMA), unstretched polymethyl methacrylate, polycarbonate (PC), polyethylene terephthalate (PET) or polyurethane (PU).

Nor does it preclude the possibility of one or more structural plies made of mineral glass. A mineral glass here refers to a thermally tempered or chemically strengthened, soda-lime, aluminosilicate, borosilicate glass.

Furthermore, in the embodiment shown in FIG. 1, the outer and inner structural plies 111, 112 have identical thicknesses (the thickness of a structural ply being counted in the transverse direction T). For example, the thickness of the outer and inner structural plies 111, 112 is between 3 mm and 30 mm, more particularly between 5 mm and 8 mm.

However, this does not preclude other embodiments wherein, for example, the external structural ply 111 has a different thickness (that is greater or lesser) than the internal structural ply 112. By way of non-limiting example, the thickness of the external structural ply 111 is 5 mm, while the thickness of the internal structural ply 112 is 6 mm.

The adhesive interlayer 113 can be made of thermoplastic polyurethane (TPU), polyvinyl butyral (PVB), ethylene-vinyl acetate copolymer (EVA), ionomer resin or casting resin. The thickness of the adhesive interlayer 113 is, for example, between 0.5 and 6 mm, preferably at least 2 mm.

It should be noted that, in the present embodiment, the structural plies of glazing 110 consist solely of the external structural ply 111 and the internal structural ply 112. Considering such a set of structural plies is, however, only one variant of the invention. This does not preclude considering other embodiments wherein said set of structural plies comprises at least three structural plies, for example four structural plies.

Furthermore, in the embodiment illustrated in FIG. 1, laminated glazing 110 also comprises a sheet of glass 114 in direct contact with the external environment 10 and attached to the external structural ply 111 by means of an adhesive interlayer 115 with similar material characteristics to those described for the adhesive interlayer 113. In addition, said glass sheet 114 is positioned overhanging the outer and inner structural plies 111, 112.

It should be noted that glass sheet 114 is a thin, non-structural protective sheet, that is, it does not provide the mechanical strength required for a monolithic glazing, for example, so it does not form a structural ply such as those described above. It can be made of mineral or organic glass, and can be between 0.5 and 5 mm thick, preferably between 2 and 4 mm.

The main internal face of the glass sheet 114 (that is, the horizontal face in contact with the adhesive interlayer 115) is for example provided with a network of wires or a thin layer such as ITO (Indium Tin Oxide), silver, gold or equivalent, electroconductive, capable of defrosting the laminated glazing 110.

In the present embodiment, and as illustrated in FIG. 1, the outer and inner structural plies 111, 112 are encapsulated at their periphery in an overmolded seal 120.

Seal 120 is made of an elastomeric polymer material, in particular one that can be injected or extruded, such as silicone, polyurethane (PU) or polysulfide elastomer, to make the glazed system 100 air-and watertight. It can also be a glued flat seal.

In the present embodiment, the laminated glazing 110 is attached to the aircraft structure 130 by means of an aircraft structure mounting element, referred to as the “upper mounting element 132,” arranged opposite the external structural ply 111 and extending in a plane substantially parallel to that of the glazing 110. More specifically, said upper mounting element 132 corresponds here to a glazing retainer bolted to the structure 130 and made, for example, of aluminum, carbon, titanium or other composite or non-composite material. The retainer 132 presses against the external structural ply 111 (more specifically, against the overhang of the external structural ply 111 with respect to the glass sheet 114) via the silicone seal 120.

The support thus created enables the assembly formed by the external and internal structural plies 111, 112 and the peripheral seal 120, to be held by clamping in the direction normal to the plane of the glazing 110 (that is, in direction T shown in FIG. 1) between:
the retainer 132, and
a mounting element 131 of the body 130, known as the “lower mounting element 131,” arranged opposite the internal structural ply 112 and extending in a plane substantially parallel to that of the glazing 110.

In this way, the lower mounting element 131 and the retainer 132 help to define, in the direction normal to the plane of the glass pane 110, a housing 150 into which the periphery of the glass pane 110 is inserted and clamped so as to hold it in place.

It should be noted that the lower 131 and upper 132 mounting elements have so far been described as two separate components of the vehicle structure. Such arrangements are not, however, limitative of the invention, and nothing of course precludes the consideration of other embodiments wherein these two elements are in one piece.

In the embodiment described here, the glazed system 100 also includes a stiffening shim 160 (also known as a compensation shim or thickness shim) housed in the lower part of the peripheral seal 120 and in contact with the lower face 112b of the internal structural ply 112, so as to help hold the laminated glazing 110 securely in its mounting position. This stiffening wedge 160 is conventionally made of a harder material than that of the seal 120, and may be solid or comprise one or more recesses.

The implementation aspects of such a stiffening wedge 160 are well known to those skilled in the art, and are therefore not further detailed here. In any case, it is important to note that the presence of said stiffening wedge 160 is, for the purposes of the present invention, optional.

The general principle of the invention is to provide the glazed system 100 with elements, known as “blocking elements,” configured to cooperate with one another when the laminated glazing 110 slips in the plane wherein it extends and oriented towards the center of said glazing 110 (that is, in the H direction of FIG. 1), so as to block said slippage.

These blocking elements comprise:
at least one blocking element, called “primary blocking element”, rigidly connected to the glazing 110 in the area where the vehicle structure exerts a clamp on the glazing 110 (that is, in the mode described here, in the peripheral encapsulation area created by the seal 120),
at least one blocking element, called “secondary blocking element”, rigidly connected to the vehicle structure.

There is no limitation on the material used to make a blocking element according to the invention. For example, a metallic material (aluminum, titanium, stainless steel, etc.), a composite material (short or long fibers (fabric or felt), glass or carbon or cotton, epoxy or polyester or phenolic resin, etc.), or a plastic material (PC, PMMA, etc.) can be considered.

It should be noted that the expression “blocking a slippage” does not mean, in the sense of the present invention, that all horizontal movements of laminated glazing 110 are prevented. Indeed, it is expected that laminated glazing 110 may undergo slight horizontal slippage during nominal operation of the aircraft, so as not to impose too great a rigidity on the glazed system 100, and thus allow mechanical stresses to be removed. The blocking elements are nonetheless configured to block any slippage likely to cause the laminated glass 110 to fall out of the housing 150, particularly in the event of breakage of all or part of the structural plies.

When the primary and secondary blocking elements are in the configuration wherein they block slippage, they are said to be in the blocking configuration, and when the primary and secondary blocking elements do not block slippage, they are said to be in the nominal configuration.

Thus, in the nominal configuration, the primary and secondary blocking elements allow the glazing to slide slightly in the plane wherein it extends, so as not to impose too much rigidity on the glazed system 100, and thus allow mechanical stresses to be removed.

More particularly, in the particular embodiment shown in FIG. 1, the glazed system 100 has a single primary blocking element 170 and a single secondary blocking element 180. The latter are respectively rigidly connected to the external structural ply 111 at the upper face 111a and the retainer 132.

The primary blocking element 170 is attached and fixed to the upper face 111a of the external structural ply 111. Similarly, in this embodiment, the secondary blocking element 180 is attached and fastened to the retainer 132. Any fastening method known to the skilled person can be used, such as bonding, sintering, brazing or bolting.

However, the fact that the primary blocking element 170 is attached and fixed to the external structural ply 111 is only one variant of the invention. Thus, nothing precludes the possibility that said primary blocking element 170 may be integral (that is, in one piece) with said external structural ply 111. This is achieved, for example, by machining, molding or forming. Similar arrangements can of course also be envisaged for holding the secondary blocking element 180 to the retainer 132.

As shown in FIG. 1, the seal 120 is located on either side of the primary and secondary blocking elements 170, 180, but also between them (that is, the blocking elements 170, 180 are not in direct contact in the embodiment described here with reference to FIG. 1). This can be achieved by any method known to the skilled worker, for example by injecting elastomer material into a suitable mold.

Furthermore, in the embodiment shown in FIG. 1, cooperation between the primary 170 and secondary 180 blocking elements takes place indirectly by means of respective contact surfaces 171, 181 of said primary and secondary blocking elements, said contact surfaces 171, 181 being inclined with respect to the plane of the glazing.

As a result of these arrangements, the contact surfaces 171, 181 are arranged opposite one another, and are configured to transmit pressure forces to the part of the seal 120 located between them when the laminated glass 110 slips in the H direction. This transmission of pressure forces, via the seal 120, characterizes said indirect cooperation and advantageously enables additional clamping of the outer and inner structural plies 111, 112 due to their inclination, so as to block this slippage.

It is understood that, in order to achieve the function of blocking slippage, the inclination of the contact surfaces 171, 181 is, in the direction from the periphery of the glazing 110 towards the center thereof, in the direction of the glazing 110. In other words, in the case of FIG. 1, this inclination is from the outside 10 towards the inside 20 of the aircraft, as the blocking elements 171, 181 are positioned at the top in relation to the plane of the glazing.

According to one exemplary embodiment, the angle of inclination of the contact surfaces 171, 181 with respect to the plane of the glazing 110 is between 5° and 60°, more particularly between 20° and 40°, preferentially equal to 25°.

The glazed system 100 according to the invention has so far been described as comprising a single primary blocking element 170 and a single secondary blocking element 180. The invention is not, however, limited by such arrangements, as other embodiments can also be envisaged.

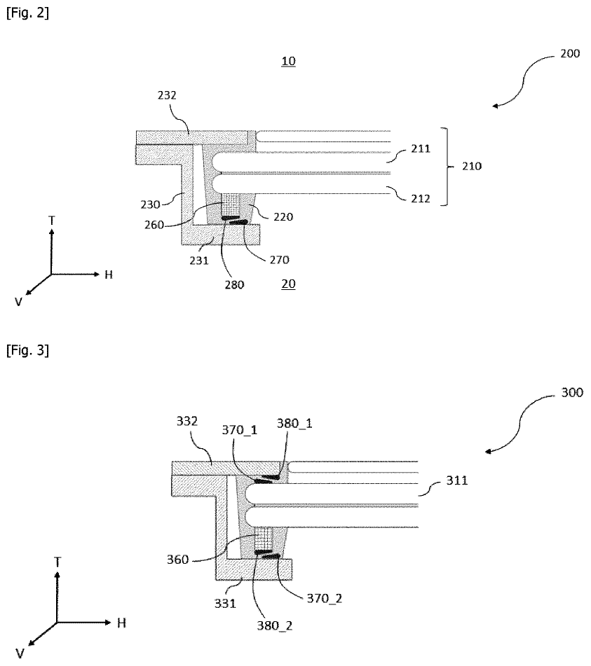

FIG. 2 schematically shows another particular embodiment of a glazed system 200 according to the invention.

Following similar arrangements to those described with reference to FIG. 1, the glazed system 200 comprises a laminated glazing 210 comprising structural plies 211, 212 encapsulated at their periphery in an overmoulded seal 220, the assembly formed by the structural plies 211, 212 and the peripheral seal 220 being clamped by the vehicle structure between:
an upper mounting element 232 (retainer), and
a lower mounting element 231 of structure 230.

The glazed system 200 also includes a stiffening wedge 260.

In this further embodiment, and as illustrated in FIG. 2, the glazed system 200 comprises a single primary blocking element 270 and a single secondary blocking element 280. These are attached to the stiffening wedge 260 and the lower mounting element 231 respectively.

In other words, the arrangement of the primary and secondary blocking elements 270, 280 is symmetrical with respect to the plane of the glazing in this embodiment, compared with the embodiment shown in FIG. 1.

Of course, all the technical provisions described above with reference to FIG. 1, with regard to holding a blocking element 270, 280 to the mounting element 260, 231 with which it is associated, still apply here.

FIG. 3 schematically shows another particular embodiment of a glazed system 300 according to the invention.

The configuration of glazed system 300 shown in FIG. 3 results from the combination of glazed systems 100 and 200 described respectively with reference to FIGS. 1 and 2.

Thus, and as illustrated in FIG. 3, the glazed system 300 comprises:
a primary blocking element 370_1 and a secondary blocking element 380_1 configured to cooperate with one another and respectively rigidly connected to the external structural ply 311 and the upper mounting element 332 (retainer),
a primary blocking element 370_2 and a secondary blocking element 380_2 configured to cooperate with one another and respectively rigidly connected to the stiffening wedge 360 and the lower mounting element 331.

Generally speaking, there is no limit to the number of blocking elements that can be considered. For example, said glazed system may comprise a plurality of primary blocking elements, for example more than two primary blocking elements, as well as a plurality of secondary blocking elements, for example more than two primary blocking elements, each primary blocking element being configured to cooperate with a single secondary blocking element. These various blocking elements are therefore associated with one another in pairs, and these different pairs can be distributed around the glazing in the peripheral encapsulation zone created by the seal.

Nor is the invention limited to the case where a blocking element is considered to be an entity of limited extent in the peripheral encapsulation zone created by the seal. In yet other embodiments of the invention, the glazed system comprises a single primary and/or a single secondary blocking element, each single blocking element extending continuously so as to form a closed loop within which the structural plies of the laminated glazing are arranged.

The invention has so far also been described in terms of embodiments wherein primary and secondary blocking elements cooperate with one another along a surface inclined with respect to the plane of the laminated glazing. However, there is nothing to preclude the possibility of other alternative designs, as long as the primary and secondary blocking elements are brought into contact to block a horizontal slippage. For example, two primary and secondary blocking elements can have complementary shapes, like two hooks.

It is important to note that other aspects described so far, with reference to the embodiments of FIGS. 1 to 3, are by no means limiting of the invention, as other alternatives may be envisaged. Thus, there is nothing to preclude the use of a glazing other than a laminated glazing, as long as it has a plurality of structural plies. By way of example, a porthole (for aircraft or ships) is conventionally a double-glazing, with the attachment between the two structural plies achieved by one or more spacer elements (usually made of silicone).

Nor is there any reason why clamped glazing configurations cannot be envisaged wherein the glazing is encapsulated without an overmolding gasket. For example, embodiments may be envisaged wherein a seal is present on the upper face of the outer ply and/or a seal is present on the lower face of the inner ply, without any of these seals covering the edge of the glazing. It is therefore understood that if the blocking elements are positioned on a side of the glazing where no seal is present, their cooperation takes place directly by bringing their contact surfaces into contact during slippage (it being understood that these contact surfaces are advantageously not in contact with one another when the glazing is not undergoing any horizontal slippage, so as to avoid blocking slight slippage of the glazing and thus not imposing too great a rigidity on the glazed system).

Even more generally, it is possible to envisage alternatives wherein no sealing element is present at the periphery of the clamped glazing.

Finally, the invention has so far been described on the basis that the glazed system is used for a vehicle. However, other applications can also be envisaged, such as use in buildings to create a burglar-proof glazing that will not fall out under its own weight in the event of breakage.

1. A glazed system comprising:
a glazing comprising structural plies, said glazing being clamped in place by a structure,
at least one primary blocking element, rigidly connected to the glazing in a zone where the clamping is exerted by the structure,
at least one secondary blocking element, rigidly connected to the structure,
said at least one primary and secondary blocking elements being configured to cooperate with one another when the glazing slips in a plane wherein the glazing extends, which slip is oriented towards a center of said glazing, so as to block said slippage, a cooperation between said at least two primary and secondary blocking elements being effected directly or indirectly by means of respective contact surfaces of said primary and secondary blocking elements, said contact surfaces being inclined with respect to the plane of the glazing, an angle of inclination of the contact surfaces with respect to the plane of the glazing being between 5° and 60°,
said at least one primary and secondary blocking elements being further configured to have a nominal configuration wherein said at least one primary and secondary blocking elements do not cooperate together when the glazing is not subjected to any slippage in said plane.

2. The glazed system according to claim 1, comprising a plurality of primary blocking elements, as well as a plurality of secondary blocking elements, each primary blocking element being configured to cooperate with a single secondary blocking element.

3. The glazed system according to claim 1, comprising a single primary blocking element and/or a single secondary blocking element, each single blocking element extending continuously so as to form a closed loop within which the structural plies are arranged.

4. The glazed system according to claim 1, wherein:
at least two primary and secondary blocking elements configured to cooperate with one another are respectively rigidly connected to an external structural ply of the structural plies of the glazing and to a mounting element of the structure arranged opposite said external structural ply, and/or
at least two primary and secondary blocking elements configured to cooperate with one another are respectively rigidly connected to a stiffening wedge and a mounting element of the structure arranged opposite an internal structural ply of the structural plies of the glazing, said stiffening wedge being housed in a seal, and attached to the internal structural ply of the glazing.

5. The glazed system according to claim 4, wherein:
said at least one primary blocking element is integral with the external structural ply or with the stiffening wedge, or
said at least one primary blocking element is attached and fixed to the external structural ply or to the stiffening wedge.

6. The glazed system according to claim 4, wherein:
said at least one secondary blocking element is integral with said mounting element of the structure arranged opposite the external structural ply or the internal structural ply, or
said at least one secondary blocking element is attached and fixed to said structural mounting element arranged opposite the external structural ply or the internal structural ply.

7. A method comprising providing a glazed system according to claim 1, for a vehicle or for a building.

8. A vehicle comprising a glazed system according to claim 1.

9. An assembly comprising a structure and a glazed system according to claim 1.

10. A method comprising providing a glazed system according to claim 9 for a vehicle or for a building.

11. A vehicle comprising a glazed system according to claim 9.

12. The glazing system according to claim 1, wherein the glazing is a laminated glazing.

13. The glazing system according to claim 1, wherein the angle of inclination of the contact surfaces with respect to the plane of the glazing is between 20°and 40°.

14. The glazing system according to claim 13, wherein the angle of inclination of the contact surfaces with respect to the plane of the glazing is equal to 25°.

15. The glazed system according to claim 4, wherein the mounting element is a retainer, and/or
the seal is an overmolded seal wherein the structural plies are encapsulated at a periphery thereof.

16. The glazed system according to claim 5, wherein said at least one primary blocking element is attached and fixed to the external structural ply or to the stiffening wedge by gluing, sintering, brazing or bolting.

17. The glazed system according to claim 6, wherein said at least one secondary blocking element is attached and fixed to said structural mounting element arranged opposite the external structural ply or the internal structural ply by gluing, sintering, brazing or bolting.

18. The method according to claim 7, wherein the vehicle is an aircraft, a railway vehicle or a ship.

19. The vehicle according to claim 8, wherein the vehicle is an aircraft, a railway vehicle or a maritime vehicle.

20. The method according to claim 10, wherein the vehicle is an aircraft, a rail vehicle or a marine vehicle.
